(19) United States
(12) Patent Application Publication
(10) Pub. No.: US 2010/0258681 A1
(43) Pub. Date: Oct. 14, 2010

(54) Flying Saucer

(76) Inventor: Jiubin Chen, Shandong (CN)

Correspondence Address: GLOBAL IP SERVICES, 7285 W. Eagle Court, Winton, CA, 95388, US

(21) Appl. No.: 12/666,772

(22) PCT Filed: Mar. 24, 2008
(86) PCT No.: PCT/CN2008/000575

§ 371 Date: Dec. 24, 2009

(30) Foreign Application Priority Data
Mar. 31, 2007 (CN) 200710014136.8
Apr. 18, 2007 (CN) 200710014342.9
May 9, 2007 (CN) 200710104365.9
May 21, 2007 (CN) 200710015613.2
Jul. 9, 2007 (CN) 200710016801.7
Oct. 25, 2007 (CN) 200710113518.6
Nov. 28, 2007 (CN) 200710114685.2
Dec. 4, 2007 (CN) 200710114857.6
Dec. 7, 2007 (CN) 20710116117.6
Dec. 10, 2007 (CN) 200710114790.6
Dec. 11, 2007 (CN) 200710115312.7
Dec. 15, 2007 (CN) 200710115993.7
Dec. 19, 2007 (CN) 200710115749.0
Feb. 1, 2008 (CN) 200810005084.2

(51) Int. Cl. B64C 39/06

(52) U.S. Cl. 244/34 A

(57) ABSTRACT

This invention provides a kind of flying saucer, which pertains to aviation vehicles area. It includes capsule, operating and controlling system, energy electrical system, inner-cabin facilities, fuel system, start-up system and ignition system. On capsule there fix capsule motion direction regulating equipment and capsule whirling steadiness regulating system. On capsule there fix fuel tank. On fuel tank there is a fuel tube. On capsule there fix a flywheel jet engine also, which includes flywheel spindle, flywheel and jetting device. Flywheel spindle connects to capsule. Flywheel is fixed on flywheel spindle. In the peripheral region of flywheel there fix several jetting devices. It can realize vertically taking off and landing. Capsule motion direction regulating equipment and capsule whirling steadiness regulating equipment are fixed on capsule. It can be simply handled, and it flies smoothly and steadily. It is convenient to change directions. In flight, flying saucer produces a spiral airflow whirling around capsule and simultaneously spirally propelling toward the bottom of capsule, which can boost the propelling speed toward the bottom of capsule. This invention has advantages of its high flying speed; it's flexible in changing directions; its high security; its low fuel costs, and so on.

### FIELD OF THE INVENTION

This invention involves the field of flying vehicles. Specifically, it is a kind of flying saucer.

### BACKGROUND OF THE INVENTION

Currently, available flying vehicles mainly include airplanes, helicopters, spacecrafts and rockets. Airplane has many flaws, for example, it has many limitations in many conditions when it takes off and lands, and most airplanes can not vertically take off or land; its flying speed is not high enough; it has a high energy consumption; its operating and controlling system is too complex in flying; it is clumsy in flying; it can not fly in certain weathers, etc. Helicopter has problems of low flying speed, high energy consumption, and can not fly in certain weathers, etc. Spacecraft has drawbacks of low flying speed; it cannot realize intergalactic flight; it has difficulties in taking off and landing; it has problems when entering atmosphere, etc. Generally, these flying vehicles are of low security, high maintaining and using costs, and so on. None of the flying vehicles available now can dive, and submarines can even not fly. Most flying vehicles cannot use nuclear power.

### SUMMARY OF THE INVENTION

This invention provides a kind of flying saucer. It can realize vertically taking off and landing. It utilizes nuclear power as source power. It has high flying speed, and compact structure. It flies smoothly and steadily. It has no limitations in flight altitude. It is excellent in operation, and can be easily operated. It is flexible in flying. It can stop at ease in the air. It can utilize both conventional fuels, and any elements in the air as nuclear fuels. It can achieve zero fuel costs through taking hydrogen atoms and quantum of outer space as unclear fuels. It is of high security and low manufacturing costs. It is superior to weather. It can vertically take off and land. It has no limitations in taking off and landing. It can enter atmosphere easily. It has low maintaining and using costs. It can dive also.

This invention employs the following technical schemes to realize the above mentioned targets: flying saucer includes capsule, operating and controlling system, energy electrical system, inner-cabin facilities, fuel system, start-up system and ignition system. On capsule there fix capsule motion direction regulating equipment and capsule whirling steadiness regulating equipment. On capsule there fix fuel tank. On fuel tank there is a fuel pipe. On capsule there is a flywheel jet engine, which includes flywheel spindle, flywheel and jetting device. Flywheel spindle connects to capsule. Flywheel is fixed on flywheel spindle. In the outer region of flywheel there fix several jetting devices, the jetting direction of which makes an angle of Φ1 with the radius of flywheel, and makes another angle of Φ2 with the plane that flywheel lies in and vertical to the plane that flywheel spindle lies in. Capsule motion direction regulating device includes direction plate and No. 1 extensometer. On No. 1 extensometer there fixes No. 1 extension lever, one end of which links direction plate. Capsule whirling steadiness regulating equipment consists regulating plate, No. 2 extensometer and friction device. On capsule there fix regulating plate and No. 2 extensometer. On No. 2 extensometer there fixes No. 2 extension lever, one end of which links regulating plate. Friction device includes active friction device, passive friction device and friction damper. On flywheel spindle there fix passive friction device. On capsule there fix friction damper. On friction damper there fix active friction device, which corresponds to passive friction device.

The further character of this invention lies in: the structure of flywheel jet engine is: on flywheel there fix gas mixing chamber, in the central section of which there opens air inlet vents. Fuel pipe corresponds to air inlet vent. In outer region of flywheel open several jetting cylinders. In the outer section of gas mixing chamber there fix air outlet vent. On jetting cylinder fix air inlet vent. Air inlet vent connects to air outlet vent. On jetting cylinder there fix igniter. Inside air inlet vent there fix air inlet channel, one end of which opens to the whirling direction of flywheel. The other end of air inlet channel opens to the tangent line direction of jetting cylinder's inner cylinder's cross section. Inside jetting cylinder fix combustion chamber and jetting chamber. The gas inlet area's cross section of jetting chamber is less than the maximum area of that of combustion chamber. Flywheel jet engine's structure is: in the outer section of flywheel there fix several turbine jet engines. On capsule there fix magnetic bearing. And on magnetic bearing there fix flywheel spindle. On capsule there fix air inlet damper. It corresponds to air inlet vent. On flywheel there opens up side air inlet vent. On flywheel there also fix cone cover. At the two ends of capsule there fix flywheel jet engines, and on top and bottom of capsule there fix capsule motion direction regulating equipment separately.

The advantages of this invention lie in: it utilizes circular motion fully, and the field's actions, and gyro's steadiness; whirling flywheel plays the role of gyro; flight altitude can be high or low; motivation device is fixed in the front of flying saucer; it can go forwards or upwards with jetting power produced by flywheel jet engine's high speed whirling; it can realize vertically taking off and landing; there fix capsule motion direction regulating equipment and capsule whirling steadiness regulating equipment; it is simple to handle; it flies smoothly and steadily; it is convenient in changing directions; in flying, flying saucer produces a spiral airflow around capsule and simultaneously spirally propels toward the underneath of capsule; spiral airflow can neutralize noise, and has little or nearly no noise in flying; meanwhile, it can produce an airflow spirally propelling with whirling speed decreasing from central section to outer section, which boost the propelling speed of airflow towards the underneath of capsule; flywheel jet engine whirls at high speed, and it can burn kinds of fuels, and it can realize nuclear reaction, and then the motivation power of flying saucer greatly increases. This invention has merits like, it has high flying speed; it has changeable flying speed; it can fly smoothly and steadily; it has simple structure; it is easy to handle; it is flexible in changing directions; it has high security; it has low fuel costs; it can vertically take off and land, and so on.

### BRIEF DESCRIPTION OF THE DRAWINGS

FIG. 1 is the main macro-structure schematic drawing of embodiment No. 1 in this invention;

FIG. 2 is a section view schematic drawing of FIG. 1 in A-A direction;

FIG. 3 is an enlargement section view schematic drawing of FIG. 2 in B-B direction;

FIG. 4 is the main macro-structure schematic drawing of embodiment No. 2;

FIG. 5 is the main macro-structure schematic drawing of double dynamical structure of this invention;

FIG. 6 is an enlargement schematic drawing of part I in FIG. 5.

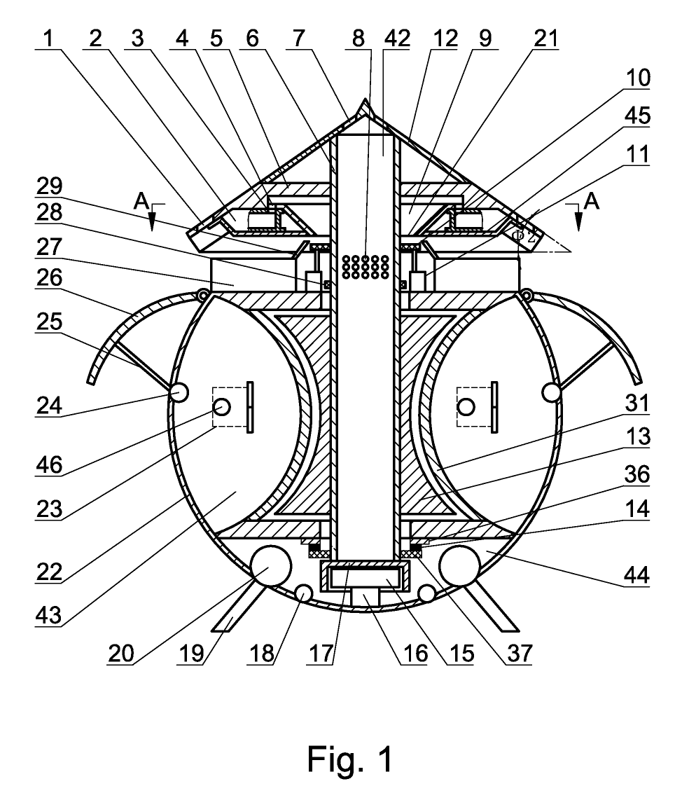

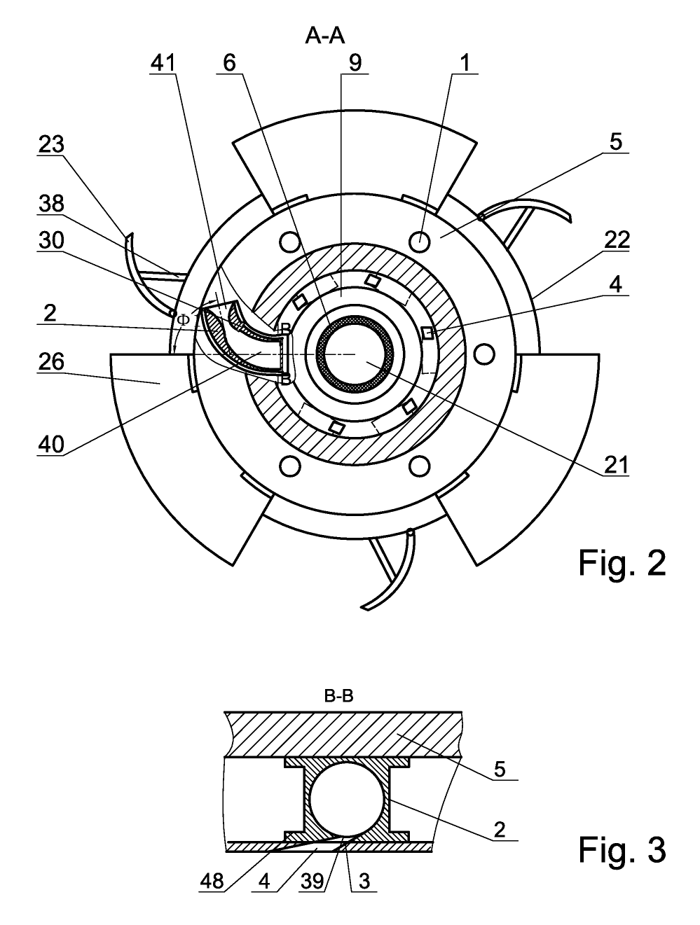

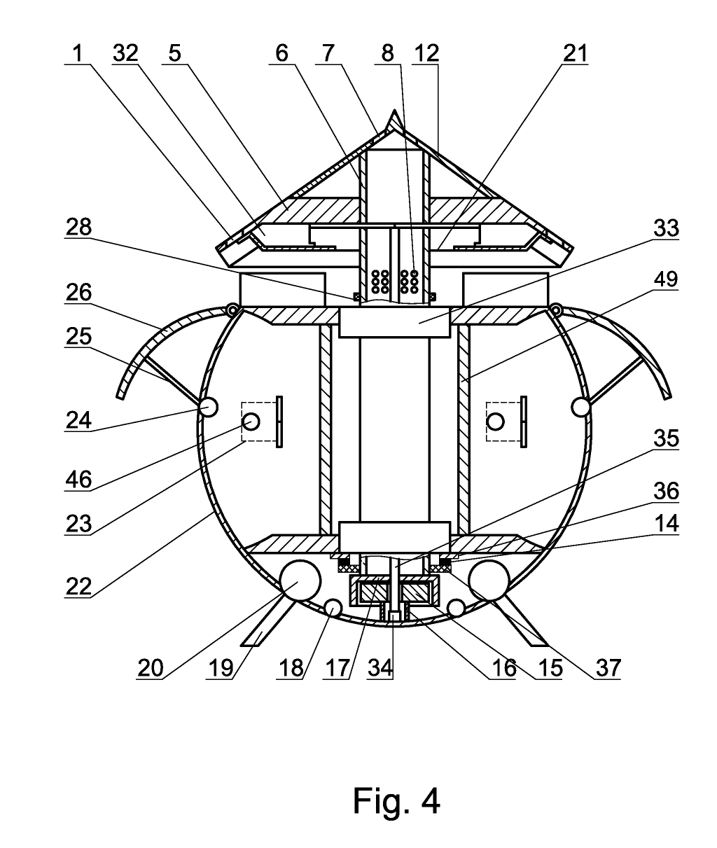

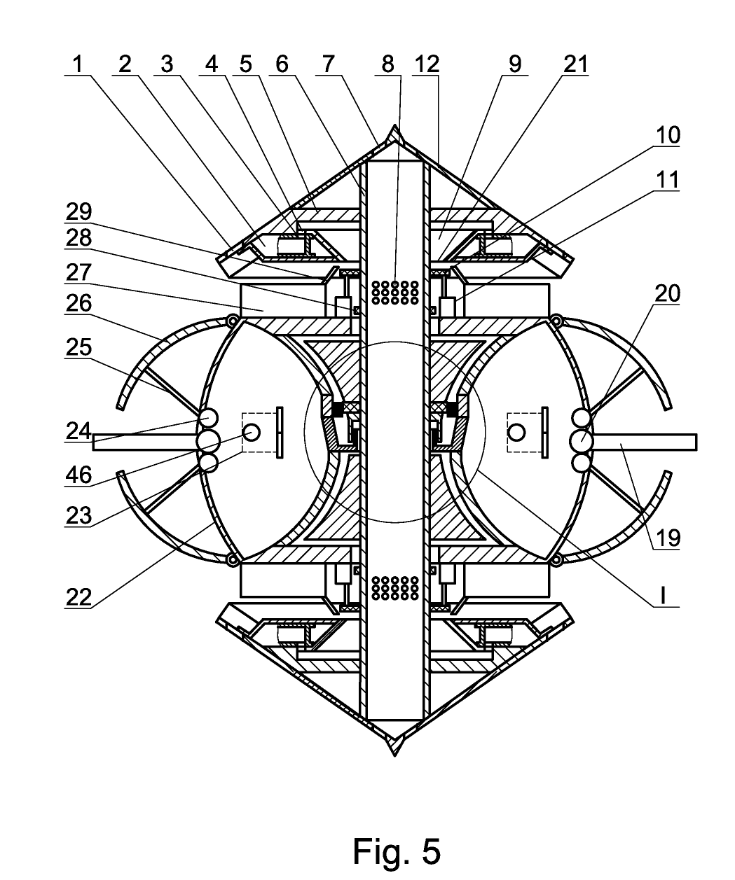

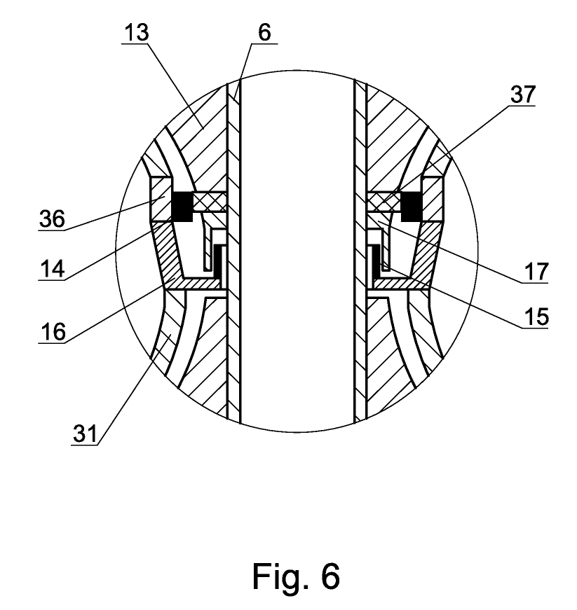

### DETAIL DESCRIPTION OF THE INVENTION

The main structure of this invention is: flying saucer includes capsule 22, operating and controlling system, engine electrical system, inner-cabin facilities, fuel system, start-up system and ignition system. On capsule 22 there fix capsule motion direction regulating equipment and capsule whirling steadiness regulating equipment. On capsule 22 there fix fuel tank 27. On fuel tank 27 there fix fuel pipe 29. On capsule 22 there fix flywheel jet engine also, which consists flywheel spindle 6, flywheel 5 and gas jetting device. Flywheel spindle 6 connects to capsule 22. On flywheel spindle 6 there fix flywheel 5. In the outer region of flywheel 5 there fix a plurality of gas jetting devices, the jetting direction of which makes an angle of Φ1 with the radius of flywheel 5. According to studies, the optimal value of Φ1 is among 55.62°-68.76°, which can help utilize a part centrifugal force to neutralize a majority of tremendous centrifugal force produced by high speed whirling. Like this, it can realize high-speed whirling, to free flywheel 5 from being separated by centrifugal force, and it can also lower the demands to the materials in manufacturing flywheel. The jetting direction of gas jetting device has an angle of Φ2 with the plane flywheel 5 lies in and vertical to the plane flywheel spindle 6 lies in. Φ2 is a non-zero angle. If angle Φ2 is too large, it will hinder flying saucer's whirling speed. If angle Φ2 is too small, it needs higher whirling speed to export stronger propelling force. The optimal value of Φ2 is among 10°-34.38°. In this range, the less angle Φ2 is, the easier the whirling speed of flying saucer to rise, and the higher whirling speed the formed spiral propelled jetting airflow becomes. It can make the propelling force become stronger, and propelling speed higher.

The diameter of capsule 22 is slight longer, but not too longer than the diameter of flywheel 5. If the diameter is too long, it will be inconvenient to operation. The diameter of capsule 22 is better if the gas jetting device cannot jet to capsule 22, the top edge of capsule 22 is close to the brink of the gas jetted out by gas jetting device, and the unfolded direction plate 26 can resist this gas. High speed flying saucer's capsule 22 diameter can be a bit shorter, and low speed flying saucer's capsule 22 diameter can be a bit longer. Capsule 22's height is same to its outer diameter. According to studies, capsule 22's optimal structure is spherical, and the sphere is the rounder the better, the outside of sphere is the smoother the better. Like this, it can lessen the resistance in flying.

The space inside capsule 22 can be divided into inner cabin 43 and bottom tank 44. The height of inner cabin 43 can be designed as 0.618 times the diameter of capsule 22. The height of small-sized flying saucer can be increased as long as possible according to the demands, to make the fullest use of space and to achieve its maximum effect. Large-sized flying saucer can be designed as a multi-layered structure, and inner cabin 43 can be designed as multi-room structure. Capsule 22 of single-room structure can be designed to be whirling structure, and whirling to the aviation status of flying saucer to maintain an unchangeable gravity center and to make it fit for sitting in. Fuel tank 27 can be fixed in the space between inner cabin 22 and flywheel 5. On fuel tank 27 there fix fuel pipes 29. Air inlet damper 11 is also fixed in this area. On-off electrical brush 28 can also be fixed in this area, in flywheel spindle 6. Flywheel spindle 6 runs through the whole inner cabin 22. It is in the central section of capsule 22. In the outside of flywheel spindle 6 there should fix isolating pipe 49. In this way, its whirling will no longer affect the inner cabin, and simultaneously isolating pipe 49 can airproof capsule 22. Between flywheel spindle 6 and capsule 22 there fix bearings. To improve the carrying capacity, a lot of bearings can be fixed in, or to fill lubricant into isolating pipe 49 to lubricate bearings. The bearing can use magnetic ones 33 to boost flywheel's whirling speed. In using magnetic bearing 33, outer magnets of magnetic bearing can be used to replace isolating pipe 49. It can save space, but can not isolate magnetic field. Strong magnetic field will attract iron wares inside cabin to magnetic bearings and make them difficult to take down. The height of the whole flying saucer basically equals to its width. In flying it forms a good sphere with whirling airflow outside cabin, which is more propitious to lower resistance and maintain smooth and steady flights.

Capsule 22 should be made in different materials according to varies flight demands. General aviation flight can use engineering plastics, or high-intensity expanded plastic in one shot. Capsule 22 shall be made in keel, and also the cabin door, and then to add some sealing measures and capsule 22 of a bit advanced can utilize shell materials of airplanes available now. Flying saucer that is used in aviation shall have its capsule 22 being made in carbon fiber materials, or shell materials of aircrafts available now.

Its facilities inside capsule 22 are simple as those facilities in cars. Advanced flying saucer has its facilities inside capsule 22 as those in airplanes. Flying saucer used in aviation flight has its facilities of the standard as those of aerospace crafts. The diameter of capsule 22 is 2 meters. It can carry 4-5 passengers. If the area of upper capsule 22 and bottom tank is made the fullest use, it is possible to sit in a man. Generally, normal flying saucer has a diameter of 2-3 meters. And of over 10 meters, flying saucer is called medium flying saucer, which can replace all the flying vehicles available now. Flying saucer with diameter of more than 100 meters is large-sized flying saucer, which can take place of space station as matrix space shuttle. Capsule diameter can be made less than 1 meter, and even less than that, to be used in other areas.

To lessen the weight of flying saucer, flywheel 5 can be made into flame type, materials of which can be high intensity ones as carbon fiber. In this way, the diameter of flywheel 5 can be made very long. Normal flying saucer can be made in normal materials. That is enough. The plane above flywheel 5 shall be made as 111.24 degree arc surfaced plane. This angle sends flying saucer suffering almost the same residence whether in level flights or in vertical flights, which is propitious for flying saucer to fly smoothly and steadily.

Capsule motion direction regulating equipment is fixed on the upper outer region of capsule 22. It includes direction plate 26 and No. 1 extensometer 24. Direction plate 26 and No. 1 extensometer 24 are fixed on capsule 22. On No. 1 extensometer 24 there fix No. 1 extension lever 25, one end of which connects to direction plate 26. Several direction plates 26 can be fixed on capsule 22, and normally 3 or 4 are enough. Direction plates 26 should distribute uniformly on capsule 22. Direction plate 26 is arc surface structured, and should be made in temperature resistant materials. The top edge line parallels to the top edge line of capsule 22. Direction plate 26 makes flying saucer steady in flight, and we can change flying saucer's direction by regulating positions of each direction plates 26. No. 1 extensometer 24 controls the positions of direction plates 26 through No. 1 extension lever 25's extending, to change flying saucer's flying direction. No. 1 extensometer 24 is controlled by flying saucer's operating and controlling system.

On capsule 22 it can fix 4 direction plates 26, which distribute uniformly in four directions of front, back, left, and right. When there is no need to change directions, direction plates 26 cling to capsule 22 closely, and closed to capsule 22. At this time, the outer shell of capsule 22 is a smooth sphere. In the top edge line of direction plate 26, there is a spindle that connects to capsule 22. This spindle is vertical to flywheel spindle 6. No. 1 extensometer 24 is controlled by central operating and controlling system. It can be controlled through handling lever, or using a set circuit system to give orders to handling lever, and No. 1 extensometer 24 receives order and finishes the extension to No. 1 extension lever 25. The regulations of open-close angle of direction plate 26 will affect whirling airflow outside capsule, and then to change the whole flying saucer's flying direction.

When it flies at high speed, flywheel 5 is in the foremost part of flying saucer. At this time, the positions of direction plates 26 are up, down, left, right. Left direction plate tilts, flying saucer flies leftwards. Right direction plate tilts, flying saucer flies rightwards. Down one tilts then it flies downwards, up one tilts and it flies upwards. When it stays in the air, flywheel 5 is above flying saucer. At this time the positions of direction plates 26 are front, back, left, right. When front direction plate 26 tilts, it flies towards slanting upper direction. When back direction plate tilts it flies toward back slanting upper direction. Left direction plate tilts it flies toward left slanting upper direction, right direction plate tilts it flies toward right slanting upper direction. When it flies at a low speed, flywheel 5 is at the slanting upper direction of flying saucer. And at this time, the positions of direction plates are also front, back, left, and right. The front direction plate 26 tilts, flying saucer will accelerate flying forward. The back plate tilts, it will decelerate flying forward. Left plate tilts, it turns left. Right one tilts, it turns right.

Direction plate 26 can be made into three pieces, distributing uniformly in three directions as left front, right front, and dead astern. The manner is almost the same with that of fixing the above-mentioned 4 direction plates 26. Only the operating is more complex. The merit is that it offers a good vision in level flight.

To avoid obstructing visions, direction plate 26 can be designed as lateral moving style. Direction plate 26 can be fixed above capsule 22. Set slide tracks on the top of capsule 22. And No. 1 extensometer 24 controls No. 1 extension lever 25 to slide direction plate 26 to and from toward the radius direction of cross section of capsule 22. The drawback of this scheme is high manufacturing costs.

Once flywheel jet engine starts up, it produces a whirling airflow around capsule 22. The whirling direction of whirling airflow is contrary to whirling direction of flywheel 5. Whirling airflow gives a propelling force to the bottom of capsule 22, and at the same time whirling airflow acts on capsule 22, to make capsule 22 produce a torque force with the same direction with whirling airflow. This torque force is contrary to the direction of flywheel 5's whirling torque force, and the two opposite forces can spur electric generator into working. Meanwhile the two forces can be used to regulate the steadiness of capsule 22, to let capsule 22 free from whirling. To better use the two forces, capsule whirling steadiness regulating equipment is fixed on capsule 22. Capsule whirling regulating equipment includes regulating plate 23 and No. 2 extensometer 46. Regulating plate 23 and No. 2 extensometer 46 are fixed on capsule 22. No. 2 extension lever 38 is fixed on No. 2 extensometer 46. One end of No. 2 extension lever 38 links regulating plate 23. No. 2 extensometer 46 controls positions of each direction plates 26 through No. 2 extension lever 38, to maintain the whole capsule's balance. Several regulating plates 23 can be fixed outside capsule 22. It can be three or four. The regulating plates 23 attributes uniformly in every direction of capsule 22. Each regulating plate 23 is like a door. They lie in the middle of capsule 22, in the belt line of it. Regulating plates 23 is arc surface structured. It has the same radian as the arc surface capsule 22. Regulating plates 23 shall cling tightly to capsule 22. In this way, the whole capsule 22 is a smooth sphere. Its height can be 0.382 times the height of inner cabin; its width is better 0.382 times one-quarter of capsule 22's circumference. Regulating plates 23 can open and close. When it opens, whirling airflow give a propelling force toward outside with the same whirling direction as whirling airflow, and this makes the affecting force of torque force from whirling airflow on capsule 22 increases; and regulating plate 23's closing affecting force decreases. The open-close side of regulating plate 23 connects to No. 2 extension lever 38. No. 2 extension lever 38 connects No. 2 extensometer 46, and through the connection to control No extension lever 38. It can use a set of circuit system. Handling lever gives orders through a set of circuit systems; No. 2 extensometer 46 receives order and then finishes the extension to No. 2 extension lever 38. Whirling spindle's edge line connects to capsule 22. In the two corners there are spindles connects to capsule 22. From whirling spindle edge line to open-close side, the direction is same to whirling airflow's whirling direction.

Regulating plate 23 can also be made into telescopic type. The plane of telescopic typed regulating plate 23 parallels to flywheel spindle 6 and the cross section radius of capsule 22. Using No. 2 extensometer 46 to control the extension of regulating plate 23 is okay. Regulating plate 23 extends out, the torque force that airflow of outside capsule gives to capsule 22 increases, and contracting torque force decreases. The structure of this telescopic typed regulating plate 23 takes up a large space, and has high manufacturing costs. Its returns are not satisfied, either. Generally, it is not used.

To better stabilize capsule 22, a friction device is fixed between flywheel spindle 6 and capsule 22. The friction device includes active friction device 14, passive friction device 37 and friction damper 36. Passive friction device 37 is fixed on flywheel spindle 6. Friction damper 36 is fixed on capsule 22. Active friction device 14 is fixed on friction damper 36. Active friction device 14 corresponds to passive friction device 37. It can adopt structures similar to automobiles brake devices, like duplicated brake, shoe brake, and so on. Starts friction device when capsule 22 whirls along whirling airflow's whirling direction. Regulate capsule 22 by means of flywheel 5's torque force to stop capsule 22 from whirling. The alternated actions of regulating plate 23 and friction device realizes the steadiness of capsule 22. Under normal conditions, friction device is seldom started, and only regulating plate 23 itself can regulate the steadiness of capsule 22, for friction device can be easily worn and torn, especially in high speed whirling conditions. Electric generator itself can play the role of friction device. And it is mainly used to do most friction device's works. Friction device is only used in specially circumstances, like when direction plate 26 stretches widely; when flying saucer speeds up; when capsule 22 influenced by whirling airflow, and so on. In weightiness conditions in space, capsule 22 can swirls at a certain speed, using the centrifugal force to generate similar gravity, to eliminate adverse reactions caused by weightlessness of astronauts.

Flying saucer's taking off and landing can be controlled by regulating whirling speed of flywheel jet engine, using accelerator to control whirling speed. Direction plate 26 is controlled by handling lever, which can swing at ease forward, backward, leftward and rightward. Handling lever can be made as handled style and handled by right hand. Regulating plate 23 and friction device are handled by left hand. Swing leftward and capsule 22 turns left, swing rightward and capsule 22 turns right. If starting friction device can make capsule 22 turn left, then swing the lever leftward to start friction device, swing the lever rightward to start regulating plate 23. It can also be designed as handlebar or steeling wheel style, and through the swirling of handlebar or steeling wheel to control capsule whirling steadiness regulating equipment. It can use foot to control accelerator, or other more advanced handling devices to control them. It can use computer system to realize automatically drive. It can be more perfect through using aviation technologies as radar, satellite positioning, and so on. Radar emitter can be fixed in the belt line of capsule 22. Cabin door is fixed under direction plate 23 or in the area of regulating plate 23. Regulating plate 23 can be fixed directly on the cabin door. Fix porthole in the vacant area of capsule 22. The handling consol of small-sized flying saucer can use camera and radar system to record outside capsule's things. From porthole people can also see a lot of things, which is useful in taking off and landing. Large-sized flying saucers always have a huge porthole, and can be used to see more things outside cabin directly.

Further character of this invention is: to guarantee a safe flight, air bag 18 can be fixed in bottom tank 44 of capsule 22. Air bags can be filled in helium gas or other gas that is comparably safe. Once flying saucer has problems, air bag can be popped out immediately, and gas filled in to produce a balloon, which can guarantee flying saucer landing slowly, and avoid air crash. The vacant area of bottom tank 44 can be used as reserve tank.

For taking off and landing for flying saucer, undercarriage extensometer 20 is fixed at the bottom of bottom tank 44 of capsule 22. Undercarriage 19 is fixed on undercarriage extensometer 20. In flying, undercarriage extensometer 20 withdraws undercarriage 19 into capsule 22. In landing, undercarriage extensometer 20 extends undercarriage 19 out of capsule 22. To guarantee steadily taking off and landing, three undercarriages 19 are fixed on flying saucer. Wheels and gearing devices can also be fixed on undercarriage 19. In this way, flying saucer can run on the ground, but the manufacturing costs will greatly increase. So this scheme is comparably suit for large sized flying saucer.

No. 1 embodiment's structure of this invention is: the structure of flywheel jet engine is: on flywheel 5 there fix gas mixing chamber 9. In the central section of gas mixing chamber 9 there fix air inlet vent 21. Fuel pipe 29 corresponds to air inlet vent. Jetting device adopts jetting cylinder 2. In the peripheral region of flywheel 5 there fix several jetting cylinders 2. In the peripheral region of gas mixing chamber there fix air outlet vent 4. On jetting cylinder 2 there opens air inlet vent 3. Air inlet vent 3 connects to air outlet vent 4. On jetting cylinder 2 there fix igniter 30. Inside gas inlet vent 4 there fix air inlet channel 39, one end of which opens to the whirling direction of flywheel 5. The other end of air inlet channel 39 opens to the direction of cross section tangent line of jetting cylinder 2's inner cabin, and simultaneously, it declining opens to gas mixing chamber 9, expanding. Inside jetting cylinder 2 there fix combustion chamber 40 and gas jetting chamber 41. The gas inletting area's cross section of gas jetting chamber 41 is less than the maximum cross section area of combustion chamber 40.

Gas mixing chamber 9's gas inlet section's diameter is shorter than that of gas outlet section. The central spindle line of gas mixing chamber 9 and flywheel 5 are at a straight line. The central spindle line of gas inlet vent 21 and flywheel 5 is at a straight line. The lumen of gas mixing chamber 9 is better made as thicker as possible, and the brim section is better made thinner. It can further elevate air pressure of the brim of gas mixing chamber 9. Gas mixing chamber 9 can be made as a whole with flywheel 5, or as segregates. Flywheel 5 can be designed as hollowed, and take this hollow space as gas mixing chamber 9. Nozzle of fuel pipe 29 is set near gas inlet vent 21. To make it better, nozzles can be several, and they are fixed around gas inlet vent 21. More nozzles can make a better mixture of fuels and air. Fuels and air will be absorbed into gas mixing chamber 9 together.

There is abstracted jetting vent between combustion chamber 40 and gas jetting chamber 41. The opening of gas jetting chamber 41 extends, and the lumen's inside diameter towards jetting direction is increasing gradually, which can well improve jetting speed, and elevate energy using rate.

Igniter 30 is fixed inside combustion chamber 40. Igniter 30 can adopt spark plug. Along up and down sideline of jetting cylinder 2 fix bases 48. The internal wall of jetting cylinder 2 should be made in smooth lines, as stream like style, especially the lines on jet orifice, which should be made more smoothly to make the motion of airflow unhindered, and alleviate abrasions. Screw traces can be carved in internal wall with the spinning direction contrary to the whirling direction of whirling airflow in jetting cylinder 2. The depth and width of screw trace can be decided according to the size radio of jetting cylinder 2. The best craving angle of screw trace is 55.62°. Reverse screw trace can aggravate the decreasing of whirling speed in the outer region of whirling airflow, and can advance whirling speed comparably in the center of airflow. At the same time, a layer shock wave is produced between cylinder wall and whirling airflow, which can better separate energy of whirling airflow from internal wall and protect internal wall. Simultaneously it can alleviate abrasions of internal wall. If the screw traces are to be taken off, it does not affect jetting cylinder 2 in the whole, except the increasing of temperature and burning loss. It increases the energy loss of internal wall to the exterior, and comparably deduce the decreasing of whirling speed of whirling airflow from central section to outer section in jetting cylinder 2, which further affects the jetting speed, the realizing of high speed whirling, and finally affects the performance of the whole flywheel jet engine. To better eliminate heat, screw trace or heat sink can be fixed in the external wall of jetting cylinder 2. To avoid too high airflow speed caused by high speed whirling, and to avoid too high temperature caused by the friction of airflow and the internal wall of gas mixing chamber 9 and gas inlet channel 39, lateral screw trace can be craved in these internal walls with an angle of inclination at the direction of airflow. Screw trace will produce a layer of shock wave, which can greatly deduce the accumulating of heat caused by friction.

Jetting cylinder 2 can be made in all kinds of materials. In normal conditions, normal engine cylinder body materials are enough. The body of jetting cylinder can employ casting technology to be made in one shot; or temperature resistant, high-strength ceramic materials, which can boost the working life. To those of high demands, high-strength materials like metals, carbon fiber, and so on, can be wrapped outside jetting cylinder 2 to strengthen its intensity. Barrel-like shell made of high-strength materials can also be fixed outside jetting cylinder 2.

In this invention, jetting cylinder 2 can adopt kinds of forms. Usually the central spindle line of lumen of jetting cylinder 2 is round arc line. If jetting cylinder 2's gas outlet end is at a straight line with flywheel 5, then its radian of lumen central spindle can be same to that of the edge of flywheel 5. Lumen central line of jetting cylinder 2 varies. Take top central spindle line as spindle center in fixing, and turn the jetting cylinder, then the angle of jetting direction and the plane flywheel lies in and vertical to the plane flywheel spindle lies in, can be regulated. This scheme is the best scheme. Whirling airflow can be easily formed inside jetting cylinder 2. It tends to jetting.

The central spindle line of the lumen of jetting cylinder 2 can adopt bending line also. Take gas vent section of combustion chamber 40 as the interjection point of the angle, and form a bending line structure of lumen central spindle line, which makes the central lumen spindle line of jetting cylinder 2 begins to bend from gas jetting vent section of combustion chamber 40. In fixing, taking central spindle line of jet jetting chamber 41 as standard, makes the central spindle line of combustion chamber 40 parallel to the radius of flywheel 5, and the central spindle of gas jetting chamber 41's lumen will form a fixed declining angle with the radius of flywheel 5. Taking the top central spindle line of jetting cylinder 2 as spindle center, turning around jetting cylinder 2, is enough for regulating the angle of jetting direction and the plane flywheel 5 lies in and vertical to the plane flywheel spindle lies in. This structure scheme of bending line is also good for the formulation of whirling airflow.

Central spindle line of jetting cylinder 2's lumen can adopt straight line also. This structure's manufacturing technology is comparably simpler, but the effect is the least desirable. It is not good for forming whirling airflow, and for simple installation.

It is better to have the area of gas outlet vent less than the area of gas inlet vent in combustion chamber 40. When the area of gas outlet vent is smaller than the area of gas inlet vent, it can advance the pressure in combustion chamber 40. But if the area of gas outlet vent is too small, it is prone to cause backfire and increase the pressure differ of combustion chamber 40 and exterior section, which results in low energy using ratio and cause energy loss. Varies jetting vents can be chosen according to varies demands and the area ratio of gas inlet vent. If the area of jetting vent is larger than that of gas inlet vent, it's prone to cause ignition problems, not favored in maintaining burning, or it can even not realize ignition at all. If the area of jetting vent equals to that of gas inlet vent, ignition and combustion can be maintained basically, only the pressure inside cylinder is affected, and ignition becomes a bit more difficult. So it is better to have the area of jetting vent a bit smaller than that of gas inlet vent. Airflow in jetting cylinder 2 is whirling airflow that propels forward. It can prolong the detention time of airflow, and to well maintain combustion. The best area ratio range of gas inlet vent and gas jetting vent is 1:0.618-1:1. The best area ratio range of gas inlet vent and combustion chamber's maximum cross section is 0.382-0.618:1. When the area of gas inlet vent is bigger than that of gas jetting vent of combustion chamber 40, it is better to fix the igniting end of igniter 30 near gas jetting vent, to achieve an easier ignition, and to avoid backfire in ignition better. Igniter 30 can adopt normal spark plug.

The jetting end of jetting cylinder 2 is best to at a straight line with flywheel 5. The length of lumen central spindle line of jetting cylinder 2 can be 0.618 times the radius of flywheel. The diameter of jetting cylinder 2's lumen cross section can be 0.382 times the length of jetting cylinder 2's lumen central spindle line. The length of jetting chamber lumen central spindle line can be 0.382 times the length of jetting cylinder 2's lumen central spindle line. Like this, jetting cylinder 2 and flywheel can have a coordinated size ratio, and so does the ratio of the width and length of jetting cylinder 2.

For the forming of whirling airflow, gas inlet vent 3 is fixed on the direction of lumen cross section tangent line of jetting cylinder 2. Gas inlet channel 39 runs along the direction of jetting cylinder 2's cross section tangent line, and has an opening at the top of combustion chamber 40, which can ensure that gas run into jetting cylinder 2 along the tangent line direction. Gas inlet vent 3's cross section can be formed in varies shapes, round, square, triangle, polygon, [symbol] irregular type, and so on. The best shape is rectangle. The long side of rectangle parallels with jetting cylinder 2's central spindle line, which is preferably to the forming of whirling airflow.

Inside gas inlet vent 3 there fix gas inlet channel 39. Gas inlet channel 39 is better opens to flywheel 5's whirling direction when jetting cylinder 2 is at work, which can make gas go smoothly into jetting cylinder 2. The reason is, the gas of gas mixing chamber 9 has a whirling speed lower than the going speed of gas mixing chamber's wall 9. It can be better embodied when flywheel jet engine's whirling speed is higher. Through this, inlet gas enters better along the direction of jetting cylinder 2's lumen cross section's tangent line, and inertia wallop can be adopted to promote the formation of whirling airflow, and whirling airflow's whirling speed can improve better. Declining angle of gas inlet channel 39 should be as small as possible, which can smooth gas inlet channel, and form streamline type. Airflow can enter jetting cylinder quite smoothly. Extending the opening of gas inlet channel 39, to guarantee airflow's entering gas inlet channel more easily. It can improve gas inlet pressure better, and avoid backfire better at the same time.

The igniter 30 of jetting cylinder 2 connects to ignition system, which includes electric power, switch, high tension transformer, electric circuit, and so on. Electric power has electric generator. Electric generator is generated by flywheel jet engine and charges up power battery. Each units of ignition system is consolidated in ignition device, which can be fixed on flywheel spindle 6. Igniter 30 connects to ignition device, and ignition circuit connects to exterior ignition circuit through electric brush on flywheel spindle 6. Insulated materials layer is fixed between electric brush and flywheel spindle 6. High tension electricity that connects electric brush goes along flywheel spindle 6 to the surface of flywheel 5 and then connects to each igniter 30. Another electric brush of high tension electricity is fixed on the clutch controlled by electric magnet. The two electric brushes together make on-off electric brush 28. Power off and on of electric magnet makes the two brushes off and on. On-off electric brush 28 can free the electric brushes from abrasion of high speed whirling. Ignition device can also not adopt on-off electric brush. Taking off clutch, leaving certain space between the two brushes, and then on-off electric brush is composed. High tension electricity is used to hit through the space between brushes and to achieve circuit intercommunication. This can also prevent causing friction of the two brushes, and further it simplifies the installation structure of electric brushes. To simplify the installation, and avoid problems as the damage of high tension circuits and so on, high tension circuits and electric brush can be taken off. Only by fixing one or several electric levers near igniter 30 below flywheel 5, and with electric lever connecting igniting circuit, it is enough to realize the ignition. It is better to fix a lap of high tension electric levers. In fixing igniter 30, binding post can be made closely to electric lever. Leave a certain space for the high tension electricity to go through and realize circuit intercommunication. In fixing one or more eclectic levers, accompany with the whirling of flywheel 5, igniter 30 will moves to the bottom of electric lever, realizes the intercommunication with high tension electricity and achieves ignition.

Ignition system can also not adopt the above mentioned ignition device, but to be made into micro ignition device, and fixed besides each igniter 30. This scheme demands high technology and high costs. Its effect is not as good as the above mentioned scheme.

Flywheel jet engine adopted magnetic bearing 33 has no contact interface that connects to capsule 22, so a grounding electrode is needed to achieve electrical circuit connection. An on-off electric brush can be fixed on flywheel spindle 6, realizing the connection of flywheel spindle 6 and high tension cathode, and forming ignition circuit as a loop.

Start-up system includes electric power, switch, electric circuit, electric generator, transmission gears, and so on. Flywheel jet engine needs the aid of start-up device to start-up, and get initial whirling speed. Start-up device can be fixed directly on flywheel spindle 6. Start-up device brings flywheel spindle 6 into whirling, and thus afford initial whirling speed to flywheel jet engine.

In this embodiment, start-up system is started first to bring flywheel 5 into whirling. After flywheel 5 whirling to a certain speed, air will be automatically taken into gas inlet vent 21. Fuel pipe 29 begins translating fuels to gas inlet vent 21. Fuels and air are automatically taken into gas mixing chamber 9. The mixing gas automatically forms a whirling airflow with whirling speed decreasing from central section to exterior section in gas mixing chamber 9, which elevates the pressure to the edge of gas mixing chamber 9. The pressure makes a uniformly mixture of air and fuels. For centrifugal force, the mixed gas goes through gas outlet vent 4, gas inlet vent 3 into combustion chamber 40 of jetting cylinder 2, and forms a whirling airflow with the whirling speed decreasing from the central section to exterior section. Igniter 30 ignites, and whirling airflow starts to burn. Whirling airflow prolongs the detention time for fuels in combustion chamber 40, which results a better mixing of fuels and air and a better burning of fuels. Once whirling airflow forms, it will produce a swirl inside combustion chamber 40. The mixed gas will wholly enter the center of whirling airflow from the swirl. The continuously entering of fuels into burning releases heat, which further accelerates the whirling speed in the center of whirling airflow, aggravates the decreasing of whirling speed from central section to exterior section, and greatly accelerates the comparably whirling speed of the center of whirling airflow. It makes most energy generalized in the center of whirling airflow. In the central section of combustion chamber 40 there shall be a circumstance of high temperature and high pressure.

High pressure gas is expelled from jetting chamber 41, and it forms a propelling force to propel flywheel 5 into whirling. The outer region of flywheel 5 also forms a whirling airflow with the whirling speed descending from central section to exterior section. This can greatly reduce noise at the same time. Once ignited, flywheel jet engine can immediately cancel exterior boosting force, and achieve self high speed revolution, and export motive force. Meanwhile, close start-up device and igniter 30.

To elevate intensity, and improve the centrifugal force resistance capability, securing plate 45 can be fixed. A hole opens in the central part of securing plate 45. It does not affect the entering of gas to gas mixing chamber 9. The securing plate 45's border reaches jetting cylinder 2. It covers the area above jetting cylinder 2. Fix securing plate 45 to each jetting cylinder 2's base 48 closely. In this way, it can greatly improve the intensity; and meanwhile it does not affect the radiating of heat. While executing, gas mixing chamber 9 can be heightened, and the border of gas inlet vent 21 and securing plate 45 can be fixed closely together. Like this, intensity can be further improved. At the brim of securing plate 45 shoe plates can be added, to further improve intensity. Shoe plate can be made a whole with securing plate 45, and then connect shoe plate to flywheel 5. It forms an integer then and makes a tighter integer.

This embodiment can achieve high speed whirling of flywheel. When flywheel 5 achieves a certain whirling speed, nuclear reaction can be realized and produce super-high motive power in jetting cylinder 2. Flywheel jet engine can use conventional fuels as engine of conventional power, and use any element as nuclear fuels. It can burn air directly, and makes the elements in the air produce nuclear reaction. It can make the hydrogen atoms produce nuclear reaction, and it even takes quantum of vacuum as nuclear fuels, which is important in universe aviation.

Working theories: From the center of whirling airflow in jetting cylinder 2 there produces a barrel like pipe of high pressure. The larger the whirling speed differs from center to outer section, the higher the pressure the central section of whirling airflow suffers. At the same time for the high-speed whirling of flywheel 5, whirling airflow whirls at high speed too along the vertical spindle. The flywheel swirls a round, whirling airflow also swirls a round along vertical spindle. Just like the moon rotates around the earth. The moon revolves a round and simultaneously rotates a round. Flywheel 5 brings jetting cylinder 2 into swirling and makes the whirling airflow inside jetting cylinder 2 revolve along flywheel spindle. It revolves a round and simultaneously rotates a round along the vertical spindle, which makes whirling airflow owes both a plane whirling torque force of its own and a vertical plane whirling torque force produced by rotating that caused by revolution. The inter affection of the two forces will separate atoms. Atoms in whirling airflow are like moon, having whirling torque force caused in revolving a round and simultaneously rotating a round.

When the whirling speed of flywheel 5 is very high, the field's vertical plane whirling of flywheel jet engine has synchronous whirling speed with that of flywheel 5, which makes a high whirling speed of vertical plane whirling field. A whirling airflow with whirling speed decreasing from central section to exterior section is formed in gas mixing chamber 9. This whirling airflow can make a good mixing of fuels and air. After atoms enter gas mixing chamber 9 from gas inlet vent 21, they are affected by field, and the field of atom itself suddenly accelerates into whirling. This sudden accelerating speed is quite high. When it achieves a certain degree, it will break the balance of atom's own field, and makes the structure of atom change into plasma. Gas mixing chamber 9 only plays a role of mixing fuels at the beginning of ignition. When flywheel jet engine achieves a certain whirling speed, the effect of gas mixing chamber 9 becomes a plasma producing machine that turns atom into plasma. The whirling speed decides whether or not atom can be transformed into plasma.

In the center of whirling airflow in jetting cylinder 2, there produce an area of high temperature and high tension. When whirling speed is high, the temperature and pressure in the central section is high. When atoms that in a state of plasma enter the central section of whirling airflow, theywill be dicedbywhirling airflow. Whirling airflow has a decreasing whirling speed from central section to exterior section. Loops of different radiuses have different linear speed, which makes inter friction among two neighbored loops. At the same time the whirling spindle of this whirling airflow has a crossed angle with whirling spindle of whirling airflow in gas mixing chamber 9. This makes the atoms at a state of plasma are diced by whirling airflow, separated, and nuclear reactions occur. The inter dicing actions of plane whirling torque force and vertical plane whirling torque force affects atoms and makes atoms produce nuclear reaction. If the whirling speed is enough high, the hydrogen atom can produce nuclear fission reaction too. Other elements can produce varies complicated nuclear reactions too.

It needs quite high whirling speed to bring about nuclear reactions. Nuclear reactions of high quality atoms can be achieved first. Gaseous atoms are more prone to realize nuclear reactions. Once ignite nuclear reaction, the whirling speed will be higher, and the temperature and pressure in the central section of whirling airflow in jetting cylinder 2 will be higher, while the temperature and pressure cylinder 2 wall suffered has few changes. With the further increasing of whirling speed, nuclear reaction will aggravates, and all kinds of elements will produce nuclear reactions. To further accelerates the speed, hydrogen atoms will produce fission reaction, at that time jetting cylinder 2 will jet energy flows constituted by quantum, neutrino, and quark materials.

Whether or not produces nuclear reaction depends on the whirling speed of flywheel jet engine. It has no matter with the size of flywheel 5, and of little connection with high temperature and high pressure conditions. It requires not very high temperature and pressure, but very high whirling speed of flywheel. Whirling flow with the speed decelerating from central section to exterior section ensures the temperature and pressure jetting cylinder suffered is not too high all the time. In universe aviation, only few fuels are enough. It can utilize a bound of hydrogen atoms as fuels in universe too. It can utilize every element as nuclear fuels.

In this embodiment, flywheel jet engine produces nuclear reactions under high whirling speed conditions. It can use air as nuclear fuels. In realizing nuclear reactions, to control flywheel jet engine, gas inlet damper 11 is fixed on capsule 22. Gas inlet damper 11 corresponds to gas inlet vent 21. Gas inlet damper 11 is usually fixed on capsule 22. It can also be fixed on flywheel 5. But if gas inlet controlling device is fixed on flywheel 5, it is prone to affect the whole intensity, and is usually not adopted. Extensometer is fixed on gas inlet damper 11. Sealing plate 10 is fixed on extensometer. The extensometer is controlled by operating and controlling system, and extensometer should be steady when the sealing plate 10 moves up and down. Magnetic bearing or other bearing devices that can bear very high whirling speed should be fixed between extensometer and sealing plate 10, to set sealing plate 10 whirling at very high speed. Make a slab staggering on sealing plate 10, and cover magnetic bearing 33 on it. In this way, the gap among magnetic bearings will have no influence on the sealing of sealing plate 10. Space among interior and exterior magnets of magnetic bearing 33 should be designed as declined or arc or slot structure, to enable it to bear the force that parallels to whirling spindle of magnetic bearing 33, and guarantee sealing plate 10 can move upward and downward. When sealing plate 10 gets close to gas inlet vent 21, the gas entering amount of flywheel jet engine decreases, and nuclear reaction's intensity deduces. Controlling sealing plate 10 also means controlling the whirling speed and power of flywheel jet engine. After sealing all the gas inlet vents 21, sealing plate 10 can whirl at high speed along with flywheel 5 and at the same time realize ceasing fire. Sealing plate 10 is outside flywheel spindle 6. It swirls synchronously with flywheel spindle 6, and it slips up and down along flywheel spindle 6. No gap is allowed between sealing plate 10 and flywheel spindle 6. Using sealing oil can help. Fix magnetic bearing on sealing plane 10. Magnetic bearing connects extensometer, and extensometer needs increase extension force to separate sealing plate 10 and gas inlet vent 21 after they are sealed. For the gas inlet vent section in high speed whirling will produce a huge absorbing force, and once sealing plate 10 connects to gas inlet vent 21, it is difficult to separate them. Then in the air there will produce choke. To avoid this situation, we must separate sealing plate 10 and gas inlet vent 21 again. So we should increase extensometer's extension force. The gas inlet vent 21 should be reinforced too, to make sure it won't move together with sealing plate 10. To achieve a better separation, sealing plate 10 can be designed as a high magnet. Around gas inlet vent 21 it can also fix a round of high magnets. Then in the magnetic field's effectiveness, they will seldom get together. To avoid fuel pipe 29 from affecting the using of gas inlet damper 26, fuel pipe 29 needs to be designed as extension style or swinging structure. After realizing nuclear reaction, fuel pipe 29 departs gas inlet vent 21, so that sealing plate 10 will no longer be affected. In this embodiment, in using conventional fuels, flywheel jet engine needs no gas inlet damper.

The merit of this embodiment is: it can use multiple fuels, realize high speed whirling and produce nuclear reactions. It has high energy using rate, high speed, high motive power, and it can burn air, realize hydrogen atoms' nuclear reaction in space. It is the optimal scheme of interstellar flight.

The structure of No. 2 embodiment in this invention is: the structure of flywheel jet engine is: it adopts turbine jet engine 32 as jetting device. In the peripheral region of flywheel 5 there fix many turbine jet engines 32. It has the same figure, size ratio, etc., and the installation method with jetting cylinder in embodiment 1. Fix many turbine jet engines 32 in the peripheral region of flywheel 5. Whirling airflow jet engine 32 connects to fuel pipe 29. In this embodiment, fuel tank 27 can be in the bottom or the top of capsule 22. When it is in the top of capsule 22, fuel pipe 29 can goes along the wall to the bottom of capsule 22. At the bottom of capsule 22 there fix whirling seat 34, on which there fix supply pipe 35. The bottom end of supply pipe 35 connects to fuel pipe 29. The top end of supply pipe 35 connects to each turbine jet engines 32. The start-up circuits of each turbine jet engines connect to the electric brush device of flywheel spindle 6. Electric brush device connects to exterior electric power source. When it starts, no start-up device is needed in flywheel spindle 6, but to use each turbine jet engine 32 directly.

To better mix fuels and air, gas mixing chamber 9 can be fixed on flywheel 5. Open gas inlet vent 21 in the central part of gas mixing chamber 9, and on the corresponding gas inlet vent fix fuel pipe 29. It can ensure a fully mixing, and at the same time it simplifies the installation of fuel pipe 29. When flywheel jet engine's whirling speed achieves a certain degree, the mixing gas inside gas mixing chamber 9 will quickly rush into turbine jet engine for the actions of centrifugal force. At this time turbine jet engine becomes a pressing start-up engine. This scheme is the best scheme to flywheel jet engine.

The character of this embodiment is: it employs usual fuels, it has complex structure, its manufacturing cost is too high, its energy consumption is large, its whirling speed is comparably low, and its capability is far less than that of the structure in embodiment 1.

For the whirling speed of flywheel 6 is high, especially in realizing nuclear reactions, it needs bearings that can bear high whirling speed to be fixed on capsule 22. Magnetic bearing 33 can be adopted. On capsule 22 there fix magnetic bearing 33, and on magnetic bearing 33 there fix flywheel spindle 6. Two or more magnetic bearings 33 can be fixed on flywheel spindle to increase the bearing capacity.

To increase the steadiness of capsule 22, and to bear a higher whirling speed, a special bearing type can be adopted. Inside capsule 22 there fix No. 1 exterior permanent magnet 31. On flywheel spindle 6 there fix No. 1 interior permanent magnet 13, which corresponds to No. 1 exterior permanent magnet 31, and together they form a large magnetic bearing. To heighten the magnetic field, we can enlarge the permanent magnet inside magnetic bearing, and fix flywheel spindle at one end of interior permanent magnet. Use interior permanent magnet directly as one part of flywheel spindle.

The structure of magnetic bearing 33 varies. Magnetic bearing 33 now available can be adopted. Simple magnetic bearing 33 can also be adopted. It can be instituted by interior and exterior permanent magnet, and it can also be the combination of permanent magnet power and electric magnet power. It can make electric magnetic power increase with the increasing whirling speed. We can fix permanent magnet, electric magnet, electric magnet cooling system in interior section, and fix permanent magnet, electric magnet, electric magnet cooling system in exterior section. Interior electric magnet and cooling system have an electric generating system, and exterior electric magnet and cooling system also have electric generating system. All electric magnets have their own special circuits. In circuit there fix rectifier to keep the direction of electric flow unchangeable, and keep the magnetic field of electric magnet unchangeable. We can use diode to control airflow. And only by whirling the electric magnet, the electric will be on. When whirling stops, electric will be off. After the electric is off, the magnetic field between the two permanent magnets can keep the interior and exterior magnets untouched, to avoid damage in mutual friction. Each electric magnet can have an electric generating loop and a set of cooling system. If it whirls, the loops can generate electric. Electric flow makes electric magnets and their cooling systems automatically work. The higher the whirling speed, the stronger the electric flow is, and the stronger the field of each electric magnet is, the larger the power of cooling system is. The cooling system of interior electric magnet can be fixed on flywheel spindle 6, and cool it down naturally through whirling. Exterior cooling system can be cooled down by liquid helium, which can greatly improve the electric conduction performance, and make the electric magnet loop achieve superconductor state, make electric magnet's magnetic field stronger, and greatly improve the whirling speed of magnetic bearing 33.

Electric generating loop system can act as start-up device and electric generating device that exports electric power outward. On flywheel spindle 6 it can fix barrel like permanent magnet, and used as exterior magnetic field of generate engine and electric generating device. To improve anti-centrifugal force capability, high tension materials can be fixed outside barrel like permanent magnet. Loops are fixed inside barrel like permanent magnet. Outside loops it fixes two electric circuits, one of which exports electric power, and another one of which is used as start-up circuit. Electric direction converting device can be fixed in this circuit. We can adopt many methods to change electric direction, using inverter, using dc-to-ac converter, and so on. We can change electric flow directions according to whirling, and makes start-up device start work. Fix a barrel-like permanent magnet in the loop. Inside barrel-like permanent magnet in loop, there fix an electric generating loop of electric magnet in magnetic bearing 33. This electric generating loop whirls synchronously with flywheel 5. By means of whirling the loop, flywheel 5 can automatically generate electric to form magnetic field of electric magnet of magnetic bearing 33, and at the same time it makes the cooling system automatically start work.

Another simple magnetic bearing 33 can be adopted too. It is instituted by inner high permanent magnet and exterior high permanent magnet. Fix electric magnet inside exterior electric magnet only. Electric magnet has a dedicated electric circuit and a set of cooling system. Cooling system can also be cancelled. As long as flywheel 5 whirls, electric magnetic can electrify and produce high magnetic field. It stops when flywheel 5 stops whirling. When electric power is off, the magnetic field between the two high permanent magnets can keep interior and exterior magnet of magnetic bearing 33 untouched, to avoid the damage caused by mutual friction.

To protect flywheel 5 and simultaneously deduce resistance of flying saucer, on flywheel 5 there fix cone cover 12. Cone cover 12 can be made a whole with flywheel 5, which can greatly improve the intensity of flywheel 5. The cone structure can male it better to utilize the centrifugal force of flywheel 5, and separate materials from the surface of flywheel. Persistence can be used to resolve a part centrifugal force producedby flywheel 5's whirling of. To deduce friction, screw trace can be fixed on the surface of cone cover 12. On the surface of cone cover 12 there is spare electric circuit for the installation of service vent. Usually the service vent of electric circuit installation is sealed with plank. It opens only when it is in use. The central section of cone cover 12's arc surface must be made into cone shape. The top of cone should be sharp, the sharper, and the better. The cone sharp angle can be 55.62 degree, which is good in deducing persistence. At the same time, radar jetting device can be fixed on cone sharp, and realize the connection of electric circuit by means of electric brushes.

To increase air inlet amount and to cool down jetting device and capsule 22, lateral gas inlet ventl is fixed on flywheel 5. It runs through flywheel 5, and lies at the gap zone of jetting device adjacent. Lateral gas inlet vent 1 should be fixed declined, through which airflow can easily enter through the swirling of flywheel 5. Part of gas goes downwards to the bottom of capsule 22 along its exterior wall, which can cool down and protect capsule 22.

To increase air inlet amount, on cone cover 12 there opens gas inlet vent 7. Inside flywheel spindle 6 there fix airflow channel 42. Flywheel spindle 6 goes through flywheel 5. On the lateral wall of flywheel spindle 6 there opens gas outlet vent 8. Flywheel spindle 6 connects to upper gas inlet vent 7. Flywheel 5 whirls at high speed and the produced gas goes through upper gas inlet vent 7 into flywheel spindle and then is jetted out through gas outlet vent 8. To increase flywheel 6's gas inlet amount and simultaneously avoid the entering of foreign bodies, we decline the grid opening of upper gas inlet vent 7 of cone cover 12, which allows more airflow entering flywheel spindle 6 accompany with the whirling of flywheel 5.

On lateral gas inlet vent 1 and upper gas inlet vent 7 there fix active impeller like grid. It can help regulate the slope angles. It can totally close, or decline. It can guarantee the entering of gas can not be affected when flywheel 5 whirls at high speed. After fully closing, it can avoid the entering of airflow or water. Each grid is brought up by a mini electric motor. When in use it opens grid, and when need closing, it closes. Electric motor is controlled by a dedicated circuit. The circuit can be connected by two on-off electric brushes fixed on flywheel spindle 6 to electric power. This scheme is useful in diving, and of no use to flying saucers that does not dive. The surface of grid and all the sections on the inner wall of airflow channels need screw trace declined along the direction the motion of airflow, which can decrease greatly friction heat.

Inside capsule 22 there fix start-up device and electric generating device. The structure of them varies. This invention offers an electric generating start-up device: on capsule 22 there fix framework 16, and on framework 16 there fix electric generating loop 15, which connects to electric generating device and ignition circuit. On flywheel spindle 6 there fix No. 2 exterior permanent magnet 17. Electric generating loop 15 is fixed inside No. 2 exterior permanent magnet 17. Framework 16 can be fixed below flywheel spindle 6, or on outer area of flywheel spindle 6 on capsule 22. Electric generating loop 15 is fixed, and No. 2 exterior permanent magnet 17 whirls around flywheel spindle 6 at high speed. Electric generating loop 15 cuts magnetic line and produce electric flow, when it is electric generating device. When electric generating loop energizes, it produces magnetic field, and brings No. 2 exterior permanent magnet 17 into whirling, and further bring flywheel spindle 6 into whirling, at which time it is a start-up device. On and off electric brush 28 is fixed on flywheel spindle 6. It connects to igniter 28 and ignition circuit separately.

The large-sized flying saucer can have a couple of jetting devices in the belt line of capsule 22 in order to realize ignition in the air. The jetting device uses jetting motivation to maintain the steadiness of capsule 22, and to guarantee a smooth starting of flying saucer.

To accelerate flying saucer, and enhance the flying stability, flywheel jet engines are fixed on capsule 22, separately up and down. On the lateral wall of capsule 22, two sets of capsule motion direction regulating devices are fixed up and down. The structure of it is same with the above mentioned embodiment. When starting one above mentioned flywheel jet engine, it will produce a whirling airflow that swirls around capsule 22 and screws forward to the other end of capsule 22. Starts the two flywheel jet engines together, the airflows they jet out are of the same whirling direction, but the propelling direction of them are opposite.

As long as whirling airflow's whirling direction is same to that of the fields around, it can achieve flying at super velocity of light. It can also make intergalactic flying saucer wholly get out of gravitation, and fly more relaxed. It can use its own field to resolve gravitation produced by fields around. It can free from the time of fields around. It can change rhythms of species inside flying saucer, and greatly improve the lives of species. It can form a field of its own meanwhile, and use the affection of its own field and of fields around to accelerate the motion of itself, just as the theory of magnetic suspension train. It can fly at super velocity of light more easily. Its super velocity of light speed is not to the fields around, but to the fields that comparably far from it. Its moving speed is practically slow, compared to the fields around it.

This invention can be made larger as an aviation matrix shuttle, carrying many mini flying saucers. The diameter of flywheel 5 can be made to several hundred meters or even longer than one thousand meters. In a short time it can fly out of Milky Galaxy, and fly into any galaxy in universe. It can be both a space station and an aviation matrix shuttle. To finish galaxy aviation it must fly through the outer space of universe, which is the area above the sun. Earth and other planets are all below the sun. Solar system is of a cone structure. Flying in outer space of universe will be fast, compared to flying in solar system area. It would surely be of super velocity of light speed.

Flywheel jet engine at the bottom of capsule 22 has jetting devices with jetting direction toward capsule 22 too. It means the two flywheel jet engine jetting devices up and down the capsule 22 both have jetting directions toward capsule 22. That is, the jetting directions of them are opposite, but the whirling direction of the whirling airflow they jet is of the same direction. In this way, seeing outside the capsule and above the two flywheel jet engine, one whirls in clockwise direction, and the other whirls in counter clockwise direction. On the two ends of capsule 22 there separately fix their own capsule motion direction regulating equipment on the two flywheel get engines. Start one flywheel jet engine, and use its corresponding capsule motion direction regulating device. Their sizes are same with single shield, so in fixing they exactly do not affect each other. Undercarriage 19 can stretch to the two ends of capsule 22 according to landing and taking off directions. It can be fixed on the belt line of capsule 22.

This embodiment can get rid of gravitation thoroughly. It can fly at super velocity of light speed with the help of magnetic field's power. It should alternately use flywheel jet engines according to the demands in flight. For example, when flying at the direction that parallels to magnetic line, it should make one flywheel jet engine flying forward and the other flying backward; when flying at the direction that vertical to magnetic line, it should fly along 45 degree angle line from magnetic line. When it arrives at a certain place, then one flywheel jet engine has been started, and the other one can be turned off. Then adjust angles, to make it turn 90 degree to the direction 45 degree angle opposite to the previous direction. Fly forward at this direction. In this way, it can finish a quick flight at the direction that totally vertical to magnetic line. When one flywheel jet engine is used, the other one can be switched off. To start up the No. 2 flywheel jet engine, be attention not switch off the one in use, until the ignition finished. At this time, the flywheel jet engine that needs to be started is also whirling at high speed, and it can be ignited directly.

This flying saucer can dive, into the deep area of sea. The whirling flywheel 5 and whirling airflow outside capsule 22 can resolve the pressure in water. Whirling airflow is a narrow protecting layer. It shields capsule 22 totally. The outward stretching force of whirling airflow exactly resolves the pressure of water. The arc surface structure above flywheel 5 can well utilize the centrifugal force of flywheel 5, to make sure materials far from the surface of flywheel 5. In this way, flywheel 5 can resolve the pressure of sea water, too. It can dive to the deepest place of the sea. In water it moves at a tremendous speed. It can achieve several thousand nautical mile or even more then ten thousand nautical mile per hour, or higher. Once it goes into water, it must power on, to keep flywheel 5 swirling at high speed, and meanwhile it also moves at high speed in water. It can settle in shallow sea. And if it increase s its weight, it can settle in deep sea, too. It can naturally enter the sea without rolling and with its bottom downwards. It can finish the science probes of human beings to the deep sea. It can finish the probe inside atmospheres of many planets. Flying saucer that flies inter-galaxy has a better diving capability when it is fixed bi-flywheel jet engine. In diving, it ignites the two flywheel jet engines, and makes one flywheel jet engine's power output a little more than that of the other one. In this way, it can dive into water breezily and slowly. In water it can have the two flywheel jet engines started together, to realize the smoothly flying up and down in water. It can steadily stop in water.

This flying saucer can fly close to the ground. Air sphere can well protect it from crash. When it flies close to the ground, it looks like a hovercraft. It has no limitations on flying height. It can fly in and out of atmosphere at ease, without worrying about the friction heat from atmosphere, not to mention it's being burned down. It can breezily decelerate outside atmosphere, and steadily stop out of atmosphere. It can fly into atmosphere breezily.

In high speed flying, it is like a whirling bullet. High speed whirling can neutralize the resistance of wind, so its speed can be very high. Small-sized flying saucer can achieve the speed of more than ten thousand kilometers per hour. Meanwhile whirling makes it a good stability like a spinning gyro. When it flies at low speed, it looks like a flying disk. It owes good stability also. Its high speed whirling flywheel and the outside whirling airflow can well protect it, which is especially important in space flight. It can widely lower the damage caused by radiation from universe rays, universe dirt, aerolites, and so on. Meanwhile it can lower the pressure capsule suffered. It can replace all the airplanes available now, and its manufacturing cost is only a small percentage of that of airplanes. Its safety has greatly improved. It has a field to protect itself from the harm of kernels in universe and aerolites. Its field can neutralize attack from any energy. Its outside atmosphere is like a plastic protecting cushion, which can free crash from aviation. It makes two flying saucers automatically bounce off to avoid crash, which is important under concentrated traffic conditions. It no longer worries about air traffic, and it can put an end to traffic accident. It can fly at a very high speed. It can form its own field, without much energy transmission from fields around. Fields around have little resistance to its motions, and there is no need to waste too much energy on resistance force. Without energy consumption, it is energy-saving, and it can fly faster.

Its flight has no limit. It can fly eternally. It can steadily stop in the air forever, too, without any fuels. It can be used as a real space station, full range. It can be in outer space or in atmosphere, and it can return to earth at ease, rise up to the sky at will. It can also be used to push minor planets that threaten earth out of orbit to avoid destructive impingement. It can utilize all fuels available, and it can use charge-free inexhaustible energy. It can take no account of energy saving problems forever.

This flying saucer can be made larger and used as cargo transportation vehicle. It can take place of train, ship, automobiles, etc., which can only be used to transport ultra-large cargos or low value cargos. The functions of cars will be the bicycles present. Highway, railway, waterway, port, etc., are no longer of consequence. It can bring thorough transportation revolutions and a series of revolutions of human society in politics, economy, and national boundaries, etc. It can thoroughly convert our life, let human beings really fly up, taking human beings into flying age. That would be an unprecedented revolution. In a short time, people can fly off Milky Way galaxy like a cork, and to any galaxy in universe. In this way we can find some planets suitable for people's living, and realize galaxy migration.

Its speed in atmosphere can achieve more than 10,000 kilometers per hour easily. It can use all fuels available now, with low energy consuming, low maintaining charges. It can replace all kinds of space and air crafts available at present, including rockets, airplane, spaceship, and space station. It can simply carry satellites to space, and pick up satellites from space. It can be used to hang satellites, and make it a dominant moon. Road, railway, bridge, waterway, airport, port, etc, will no longer be important, or even of no use. It can bring a through traffic revolution, and a series revolutions of human society of politics, economies, national boundaries, etc. It can thoroughly convert people's life, let people really fly up, taking human beings into flying age. It can achieve any place in the earth in half an hour. It can thoroughly convert the habits of living together in cities of human beings, thoroughly convert the living conditions of human beings, thoroughly solve the problems of city circumstances, human population problems and problems it brings interrelated to energy, traffic, resources, environmental problems, etc, and leads human beings into space age, really and truly. Use the aviation route of universe mentioned above, in a short time, human beings can fly off Milky Way galaxy like a cork, and fly to any galaxy in universe. In this way we can find some planets suitable for people living, and realize galaxymigration. People can easily go back and forth all galaxies, and find more new lives. That would be an unprecedented species revolution, a human beings revolution in its real meaning. It would thoroughly divert the definitions of human beings. Earth people will become a history, new people will be born. Human beings will be defined as universe people, and the definition of earth would be the real cradle of human beings. That would be a huge revolution of biological evolution, of species, of human beings, and of life.

This invention's technology scheme is not limited to the range of the above mentioned embodiments. The technologies that this invention does not specifically descript are all well-known publicly.

1. A flying saucer comprising:
a capsule (22), an operating and controlling system, an energy electrical system, an inner-cabin facilities, a fuel system, a start-up system and an ignition system;
a capsule motion direction regulating equipment, a capsule whirling steadiness regulating equipment being fixed on the capsule (22);
a fuel tank (27) fixed on the capsule has a fuel pipe (29);
a flywheel jet engine, which includes a flywheel spindle (6), a flywheel (5) and a jetting devices;
the flywheel spindle (6) is connected to capsule (22), On flywheel spindle (6) the flywheel (5) is fixed, in a peripheral region of the flywheel (5) a multiple of jetting devices are fixed therein, the jetting device has a jetting direction making an angle of Φ1 with a radius of the flywheel (5), and making another angle of Φ2 with a plane that the flywheel (5) lies in but vertical to a plane that flywheel spindle (6) lies in.

2. The flying saucer of claim 1, wherein a capsule motion direction regulating device includes a direction plate (26) and a No. 1 extensometer (24); on the No. 1 extensometer (24) a No. 1 extension lever (25) is fixed, one end of the No. 1 extension lever (25) links the direction plate (26).

3. The flying saucer of claim 1, wherein a capsule whirling steadiness regulating equipment includes a regulating plate (23), a No. 2 extensometer (46) and a friction device; on the capsule (22) a regulating plate (23) and a No. 2 extensometer (46) are fixed therein, on the No. 2 extensometer (46) a No. 2 extension lever (38) is fixed, one end of the No. 2 extension lever (38) connects a regulating plate (23); a friction device includes an active friction device (14), a passive friction device (37) and a friction damper (36); on the flywheel spindle (6) a passive friction device (37) is fixed, on the capsule (22) the friction damper (36) is fixed, on the friction damper (36) the active friction device (14) corresponding to the passive friction device (37) is fixed.

4. The flying saucer of claim 1, wherein the flywheel jet engine comprising: a gas mixing chamber (9) is fixed on the flywheel (5), an opens air inlet vent (21) is in a central section of the gas mixing chamber (9), a fuel pipe (29) corresponds to air inlet vent (21), many jetting cylinders (2) are fixed in a peripheral region of flywheel (5), an opens air outlet vent (4) is fixed in a peripheral region of gas mixing chamber, a gas inlet vent (3) is opened on the jetting cylinder (2), the gas inlet vent connects to a gas outlet vent (4), a igniter (30) is fixed on the jetting cylinder (2), a gas inlet channel (39) is fixed inside the gas inlet vent (4), one end of the gas inlet channel (39) opens to whirling direction of flywheel (5), other end of the gas inlet channel (39) has a same direction with a tangent line of a cross section of the jetting cylinder (2)'s lumen, Inside jetting cylinder (2) there is a combustion chamber (40) and a gas jetting chamber (41), an area of a gas inlet cross section of the gas jetting chamber (41) is less than the same of a maximum cross section of the combustion chamber (40).

5. The flying saucer of claim 1, wherein the flywheel jet engine is constructed by that multiple of turbine jet engines (32) are fixed in the peripheral region of flywheel (5).

6. The flying saucer of claim 1, wherein on the capsule (22) has a magnetic bearing (33), and the flywheel spindle (6) is fixed therein.

7. The flying saucer of claim 4, wherein an air inlet damper (11) corresponding to air inlet vent (21) is fixed on the capsule (22).

8. The flying saucer of claim 1, wherein a lateral air inlet vent (1) is fixed on the flywheel (5).

9. The flying saucer of claim 1, wherein a cone cover (12) is fixed on the flywheel (5).

10. The flying saucer of claim 1 wherein on the two ends of capsule (22) there fix flywheel jet engines are fixed on two ends of the capsule (22), capsule motion direction regulating equipments are fixed on top and bottom of the capsule (22) separately.

11. The flying saucer of claim 2, wherein on the two ends of capsule (22) there fix flywheel jet engines are fixed on two ends of the capsule (22), capsule motion direction regulating equipments are fixed on top and bottom of the capsule (22) separately.

12. The flying saucer of claim 3, wherein on the two ends of capsule (22) there fix flywheel jet engines are fixed on two ends of the capsule (22), capsule motion direction regulating equipments are fixed on top and bottom of the capsule (22) separately.

13. The flying saucer of claim 4, wherein on the two ends of capsule (22) there fix flywheel jet engines are fixed on two ends of the capsule (22), capsule motion direction regulating equipments are fixed on top and bottom of the capsule (22) separately.
